(19) United States
(12) Patent Application Publication
(10) Pub. No.: US 2013/0305269 A1
(43) Pub. Date: Nov. 14, 2013

(54) HIGH DEFINITION PLAYBACK VERIFICATION

(71) Applicant: OPENTV, INC., San Francisco, CA (US)

(72) Inventors: Amit Verma, Sunnyvale, CA (US); Huy Quan, San Jose, CA (US); James Sullivan, Hingham, MA (US); Samir Vora, Sunnyvale, CA (US)

(73) Assignee: OpenTV, Inc., San Francisco, CA (US)

(21) Appl. No.: 13/756,410

(22) Filed: Jan. 31, 2013

Related U.S. Application Data
(60) Provisional application No. 61/645,013, filed on May 9, 2012.

(51) Int. Cl. H04N 21/2543

(52) U.S. Cl. CPC H04N 21/2543
USPC 725/5

(57) ABSTRACT

An advertisement delivery system includes a billing system that provides a plurality of schedule files providing time and zone information for inserting advertisement in a first delivery format and in a second delivery format to subscribers of a cable television network, an ad inserter that inserts advertisements according to the plurality of schedule files, and a merge module that receives a first plurality of log files that provide information about advertisement playback status for the first delivery format and a second plurality of log files that provide information about advertisement playback status for the second delivery format and merges the first plurality of log files and the second plurality of log files according to a set of rules to produce a plurality of merged log files, and delivers the plurality of merged log files to the billing system.

### PRIORITY CLAIM

This document claims the benefit of priority under 35 U.S.C. §119(e) from U.S. Provisional Patent Application Ser. No. 61/645,013, entitled “High definition playback verification,” filed on May 9, 2012, which is incorporated herein by reference in its entirety.

### TECHNICAL FIELD

The present disclosure relates to the fields of digital cable networks and digital advertisement insertion.

### BACKGROUND

Various commercial cable television systems usually deliver content to subscribers in a single, analog delivery format. In the United States, for example, analog content delivery systems were based on the National Television Standards Committee (NTSC) audio/video format. Advertisements inserted in the television programs were also delivered in the same delivery format. Advertisers were typically charged fees by content owners or cable operators based on how many subscriber homes were reached by the advertisements.

With the advent of compressed digital video, e.g., using the Moving Pictures Experts Group (MPEG) or the H.264 compressed video formats, digital cable delivery systems can deliver content in multiple delivery formats such as standard definition (SD), high definition (HD), three-dimensional (3D) programming, etc. Advertisements accompanying content in these different formats can also be delivered in these multiple delivery formats.

### SUMMARY

Techniques are disclosed for generating advertisement playback reports in content delivery systems that deliver content and advertisements in multiple delivery formats. Playback data is individually collected for each delivery format and from a network zone such as all subscribers served by a cable headend. Mechanisms are provided for a user to be able to specify merging rules that are used to merge playback log files for advertisements in different delivery formats. Merged log files are provided to a billing system. One example of merging rules includes using a thresholding technique specified by a contractual arrangement between an advertiser and a network operator. Another example merging rule uses a weighted average between different delivery formats.

In one aspect, a method, an apparatus and a computer program product storing code for reporting advertisement playback in a content distribution system to a billing server include receiving, at a computer in the content distribution system, a plurality of log files from the content distribution system, each log file comprising information about channels listed an advertisement order and playback status for advertisement spots listed in the advertisement order for each channel, wherein, the plurality of log files includes, for at least one channel, a first log file for delivering a program in a first delivery format and a second log file for delivering the program in a second delivery format, merging the received plurality of log files using a merge rule to produce merged log files and generating an advertisement playback report based on the merged log files.

In another aspect, an advertisement delivery system deployed in a cable television network includes a billing system that provides a plurality of schedule files providing time and zone information for inserting advertisement in a first delivery format and in a second delivery format to subscribers of a cable television network. The advertisement delivery system also includes an ad inserter that inserts advertisements according to the plurality of schedule files. The advertisement delivery system also includes a merge module that receives a first plurality of log files that provide information about advertisement playback status for the first delivery format and a second plurality of log files that provide information about advertisement playback status for the second delivery format and merges the first plurality of log files and the second plurality of log files according to a set of rules to produce a plurality of merged log files, and delivers the plurality of merged log files to the billing system.

These and other aspects and their implementations are described in greater detail in the drawings, the description and the claims.

### BRIEF DESCRIPTION OF DRAWINGS

Embodiments described herein are illustrated by way of example and not limitation in the figures of the accompanying drawings, in which like reference numbers indicate similar elements and in which:

FIG. 1 is diagrammatic representations of a content delivery network.

FIG. 2 is diagrammatic representations of another content delivery network

FIG. 3 is a block diagram illustrating components of a machine, according to some example embodiments, able to read instructions from a machine-readable medium and perform any one or more of the methodologies discussed herein.

FIG. 4 is a block diagram representation of architecture of an advertisement playback reporting system.

FIG. 5 illustrates the operation of a rules based log file merging process.

FIG. 6 is a tabular representation showing results of merging operations according to various rules.

FIG. 7 is a flowchart representation of an advertisement playback verification process.

FIG. 8 is a block diagram representation of an apparatus for advertisement playback verification.

### DETAILED DESCRIPTION

Advertisements are an important source of revenue to content providers (e.g., movie or television show producers) and network service providers (e.g., multi-system cable operators, or MSOs). Therefore, a reliable audit report that provides a verification that scheduled advertisements were indeed played in the content delivery network is important to advertisement revenue generation.

Digital compression technologies have been implemented by cable networks to deliver the TV content and advertisements in multiple delivery formats such as standard definition (SD) television, a high definition television format or 3-dimensional television format etc. A typical SD delivery format uses a video pixel resolution comparable to that of the legacy analog delivery systems (e.g., less than or equal to 720 horizontal×480 vertical pixel resolution). A typical HD transmission uses a resolution that is higher than the SD resolution, e.g., upwards of 1200 horizontal×720 vertical pixel resolution. Furthermore, while SD and HD are delivery formats, user's set-top boxes and television sets may decode and display the content in possibly a different viewing format.

The emergence of multiple delivery formats, on one hand, provides an opportunity for advertisers, content providers and network service providers reach audiences and generate revenue more effectively, but on the other hand, makes the task of advertisement playback reporting more complex due to the additional complexity and multiple formats.

Several products currently available in the market, including Eclipse/xG advertisement and billing management solutions by OpenTV, provide effective solutions for verifying advertisement playback in the SD format. These products also can schedule insertion of HD advertisements, but often the report generated for HD playback is not independently generated, but re-uses information for the corresponding SD playback. In some operation modes of these products, HD playback is deemed to have been successful if and only if the corresponding SD playback was successful. These features impose limitations in various circumstances.

The techniques provided in the present document can be used to solve the above discussed problems, and others. In various implementations of the described techniques, for example, an advertisement verification system receives log files from different headends. These log files include information about success/failure of advertisement playbacks on each channel, which corresponds to a single delivery format. The user (network operator or advertiser) is allowed to specify a rule, or a set of rules, that are then used to merge log files representing the different video delivery formats. Merged log files are generated and presented to the billing system. The described techniques can be used to enable advertisers, cable operators and content owners to impose a set of rules that can distinguish between success of playbacks in different formats and also charge advertisement fees differently according to different formats.

Section headings are used in the description only for ease of explanation and do not limit in any way the scope of the disclosed subject matter.

Overview

When an advertisement is ordered by an advertising provider it may either be played in SD or HD format on the viewer's television. Typically advertisements are placed as orders, and these orders are placed months in advance and cover the purchase of advertisements over a period of a week to several months. These orders are placed by or on behalf of an advertiser. Each order is made of order lines and specifies a number of spots purchased, the period of time, and the parameters to obtain a number of impressions in a desired demographic or other set of audience characteristics. Parameters may include the quantity of spots desired, the parts of the day and the days of the week for those advertisements, the network or group of networks, a region or group of regions, HD or SD content, and program where those advertisements are to play. These parameters are for illustration only and do not define the scope of the subject technology.

When a user or advertiser places an order request for an advertisement the order is first designated to a specific TV broadcast network termed as headnet which is designated to serve customers in a specific geographic zone. Each advertisement in the headnet is then scheduled for a specific time slot based on the parameters of the order. Once the schedule is determined a copy is made of the headnet schedule, and one copy is assigned as the primary schedule and the other copy is assigned as the secondary schedule. The primary schedule or the secondary schedule may contain either HD or SD formatted content, but each schedule may only contain one type of format. The advertisements are then inserted on the broadcast stream. A verification log or record is kept of everything that has been played for both primary and secondary schedules for each headnet.

This document describes, among others, systems and methods to verify playback of high definition (HD) content. Some embodiments extend to a machine-readable medium embodying instructions which, when executed by a machine, cause the machine to perform any one or more of the methodologies described herein. Other features will be apparent from the accompanying drawings and from the detailed description that follows. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Only for clarity, various embodiments are described below using examples of two video delivery formats: SD and HD. However, the techniques can be extended to delivery using other formats, such as 3D TV format. Some current technologies that monitor the flow of SD advertising content for billing purposes are limited to the number of headnets that can be concurrently verified. Since there are limited numbers of headnets it is difficult to accommodate for the increased need to verify playback of HD content as well as SD content. Current systems allow for HD content to be passed and played through a secondary list but do not have the ability to verify whether the HD list was successfully played, hence impacting the accuracy of the advertiser's billing rate.

Examples of System Architectures

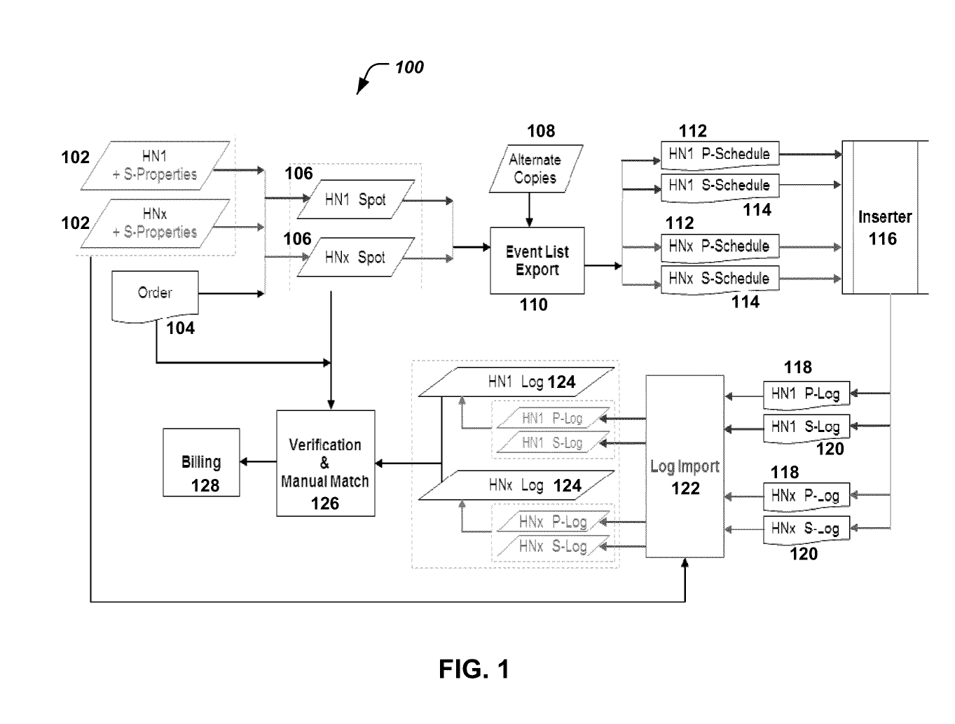

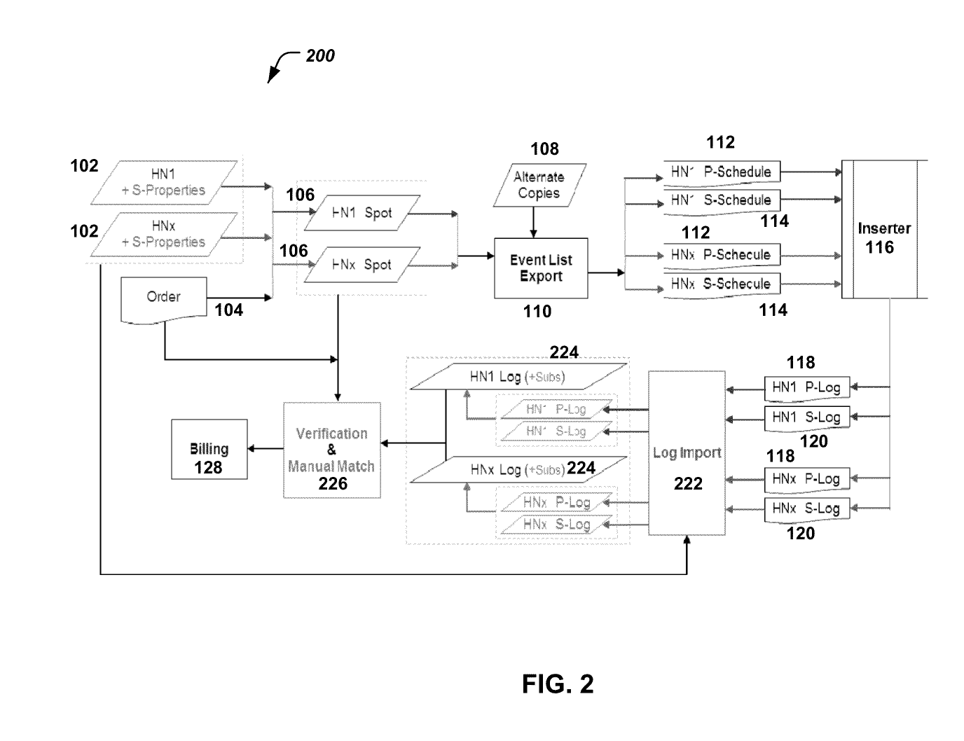

FIG. 1-2 described below illustrate two embodiments for verifying the playback of advertisements.

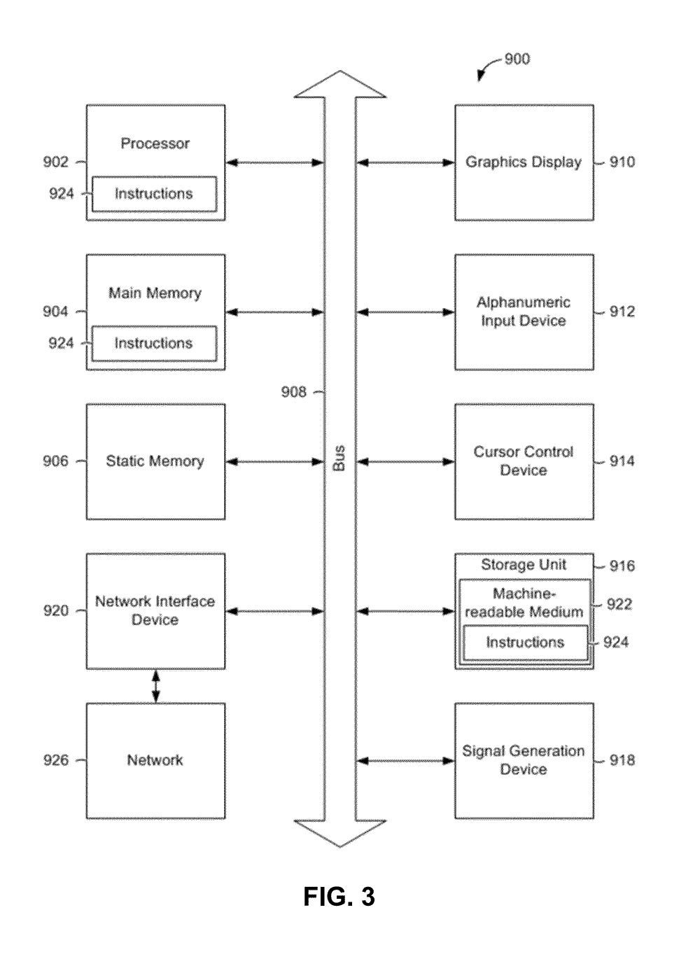

FIG. 1 is a diagrammatic representation of a network 100 in which high definition playback verification can be performed. As shown in FIG. 1, the network environment 100 may include an order module 104, an event list exporter 110 coupled with an alternate copier 108, an inserter 116, a log importer 122, a verification and manual match module 126 and a biller 128, all communicatively coupled as shown via a network. Moreover, the order module 104, the event list exporter 110 coupled with the alternate copier 108, the inserter 116, the log importer 122, the verification and manual match module 126 and the biller 128, may each be implemented in a computer system, in whole or in part, as described below with respect to FIG. 3.

The order module 104 may receive advertisement insertion orders.

The event list exporter 110 may convert the orders and advertisement spot information to primary schedules 112 and secondary schedules 114 for transmittal to the inserter 116.

The alternate copier 108 may provide secondary schedule (S-Schedule) information such that secondary advertisements can be inserted when primary advertisements cannot be inserted for some reason. Conventional television systems typically insert secondary advertisements opportunistically and do not provide playback verification data for secondary advertisements.

The inserter 116, also sometimes called ad inserter or advertisement inserter, is described in greater detail below. The verification and manual match module 126 is described in greater detail below and may, in the examples described herein, functionally be similar to the LogMerge module described in this document.

More specifically, FIG. 1 illustrates an example of an SD “AND” HD verification approach where the Log Import 122 merges the primary and secondary logs 118, 120 into one combined log for each headnet 102. The Log Import 122 receives two separate logs, one for the primary content (118) and one for the secondary content (120). Then the combined log (124) is created by using an “AND” operator on the primary and secondary logs. For example, if the primary log 118, which played SD content, indicates that the content has been played but the secondary log 120, which played HD content, indicates that the content has failed to play then the combined log (124) will indicate that the content was not successfully played. In another example, if both the primary and secondary logs 118, 120 indicate that the content was played for both SD and HD formats successfully, then the combined headnet log 124 will indicate that the content was successfully played. Thus, under this embodiment, both SD and HD content are played in order to receive a successful combined playback result. The result of each advertisement on each headnet is then reported back to the billing module 128 which bases the advertising campaign pricing on the successful playback of both the SD and HD content.

FIG. 2 illustrates a cable network 200 based on the threshold verification approach where the success of the advertising campaign is based on whether the number of HD and SD subscribers reaches the number designated by the advertiser's order. The Log Import module 222 receives two separate logs one for the primary (118) and one for the secondary content (120). The Log Import module 222 then extracts the number of subscribers for each advertisement from each log such that there is a separate number of HD subscribers and separate number of SD subscribers for each advertisement in the headnet.

In some implementations, the Verification and Manual Match module 226 takes the subscriber data to determine whether, and how much, the advertisement campaign was successful. The success criteria may be specified by a business arrangement between a cable operator and an advertiser and may be communicated to the system 200 as an advertisement playback reporting rule. For example, when the user (e.g., an advertiser or a cable network operator) first places an order, a designation is made as to the number of subscribers to be used for each advertisement to be considered successful. The designation may, e.g., be specified as a threshold. In one illustrative example, e.g., if an advertisement reaches over 90% (a pre-specified threshold) of subscribers of a headnet, then for reporting and billing purpose, the entire headnet is considered to have received the advertisement. In another illustrative example, based on the rule may specify that the advertisement campaign is considered to be successful in the headnet only if 30,000 or more subscribers received the advertisement.

In some implementations, the Verification and Manual Match module 226 takes the pre-designated number from the advertisement order and matches it to the combined number of SD and HD subscribers. If the combined number exceeds the pre-designated number, the advertisement campaign is considered successful. Otherwise the advertisement campaign has not met the goal and is unsuccessful. In this embodiment, a campaign goal is to get as many viewers of the right characteristics to notice or respond to the advertisement for a given cost of placing the advertisement. The advertisement provider states the campaign goal parameters for each order. This embodiment allows the user to know how many subscribers of each format received the advertisement and verifies that the HD and SD content were played.

In some implementations, the data in the combined headnet log is separately used to generate a report for the user regarding specific data and details of the insertion. In one example, the combined log may allow the user to see how many HD advertisements were placed versus SD advertisements. The user can learn of which zones or clusters of households have more HD capable STBs verses SD only STBs.

In certain implementations, HD boxes may play SD content in zones which do not have HD capability. In such implementations, the Verification and Manual Match module 226 automatically places a unique weight on those devices which are HD capable but insert SD content. The unique weight is a linear combination of the value of a user's order and the user's pre-designated weight given to HD content insertion. The value of a user's order may be determined by the parameters of the order. When a user requires a larger subscriber count or larger number of HD insertions for campaign success, the weight placed on the order is higher than orders with lesser requirements. A user pre-designates a weight for HD versus SD insertion in the order indicating which format of insertion is more critical.

Consider an example where an order may specify 80% of HD insertions and 20% of SD insertions. In this case, a higher weight is given to HD insertion, but the insertion occurs in a zone that cannot place HD content, so the value or weight given by the user affects the unique weight of actual insertion as calculated by the Verification and Manual Match module. The unique weight placed on actual insertion allows users to see that not all HD content may have been delivered on HD capable devices. For orders where a user indicates a preference for HD delivery this weight impacts the data that is automatically reported back to the user so that the user may modify the placement of the next order if needed.

In another example, users may indicate that a higher weight should be placed on insertions that were actually played, i.e., watched by a subscriber. An insertion that was placed on a STB where the television was on will receive a higher weight than when a television that was off. This weighted factor is reported back to users and allows users to identify zones where content more effectively reaches viewers.

In another embodiment, the data in the combined headnet log records instances where there are multiple SD and HD capable devices in a cross-zone or multi-zone so that single insertions are not counted multiple times. In one example embodiment, there may be multiple STBs with both HD and SD capability in the same household. When there are devices with different capabilities the Verification and Manual Match module places a separate weight for each device where an advertisement was inserted based on the type of device, the number of related devices in the household and the total number of devices in the household. This linear combination of weighted values for each device in a multi-zone environment affects the determination of campaign success. This data may be reported back to the user for future analysis if needed.

In another example embodiment there may be STBs with either HD or SD capability in a cross-zone environment. In this case the insertion on a single device should not be counted for more than one zone. When devices are located in the intersection of multiple zones, a unique tag is automatically assigned to those devices. The Verification and Manual Match module recognizes the tag and the number of zones the device may be connected to and places a weight on the data from that device. Thus, when the data for the total number of insertions are recorded in the log the Verification and Manual Match module takes into account for devices that may have been recorded in the log multiple times. This linear combination of weighted factors affects the pricing and billing for the user.

FIG. 3 is a block diagram illustrating components of a machine 900, according to some example embodiments, able to read instructions from a machine-readable medium (e.g., a machine-readable storage medium) and perform any one or more of the methodologies discussed herein. Specifically, FIG. 3 shows a diagrammatic representation of the machine 900 in the example form of a computer system and within which instructions 924 (e.g., software) for causing the machine 900 to perform any one or more of the methodologies discussed herein may be executed. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 (e.g., network 190) via the network interface device 920.

Examples of Embodiments

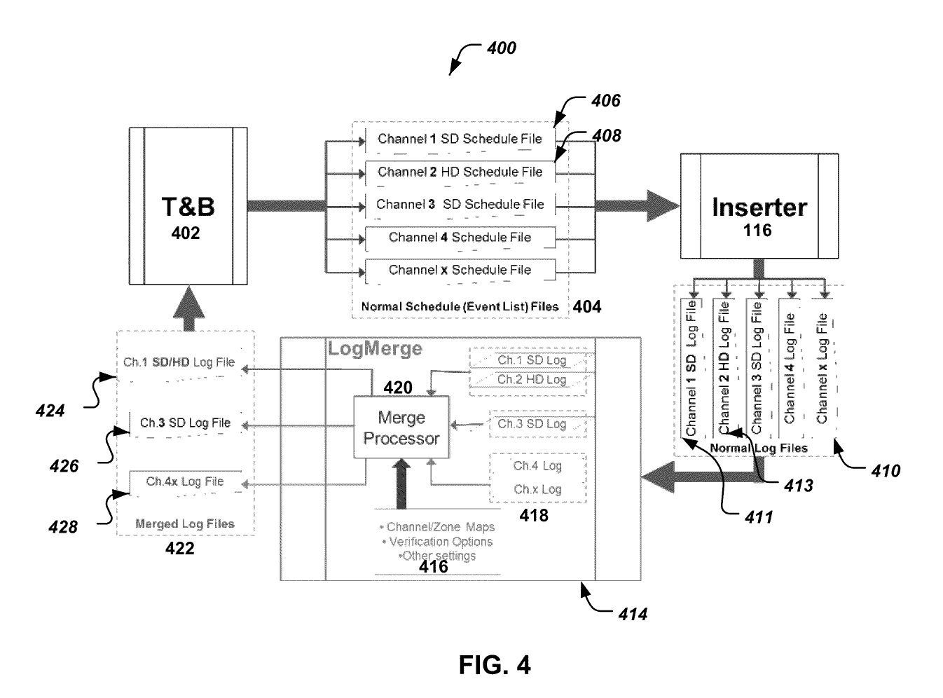

FIG. 4 represents block diagram architecture 400 of a LogMerge module 414. As previously discussed, a traffic and billing function 402 may generate multiple normal schedule (event list) files 404 that include, e.g., a SD schedule for an SD channel, an HD playback schedule file for an HD channel, and so on. These schedule files 404 are provided to an ad inserter 116. After the scheduled ads are played out (or fail to play out but the time at which these ads were to be played out has expired), the inserter 116 may generate indication about success/failure in inserting the ads specified in the schedule files 404. The log files 410 may be generated, one log file for each schedule file.

The log files 410 are provided to the LogMerge module 414. A first function performed by a module in the LogMerge module 414 includes parsing the log files 410 to generate logs for each advertisement. Another module may apply a channelization/zone map and other verification options or rules (e.g., discussed below) and other relevant settings, 416 to a merge processor 420. The Merge processor 420 uses the inputs 416, 418 and produces merged log files 422. For example, merged log file 424 includes logs 411 and 413 for SD and HD delivery format versions of the same programming content. The log file 426 may include merged log file for the corresponding SD event list file. Whereas, merged file 428 may merge results of Channel 4 and channel X (e.g., another format) according to merge rules specified by the user.

Examples of Rules

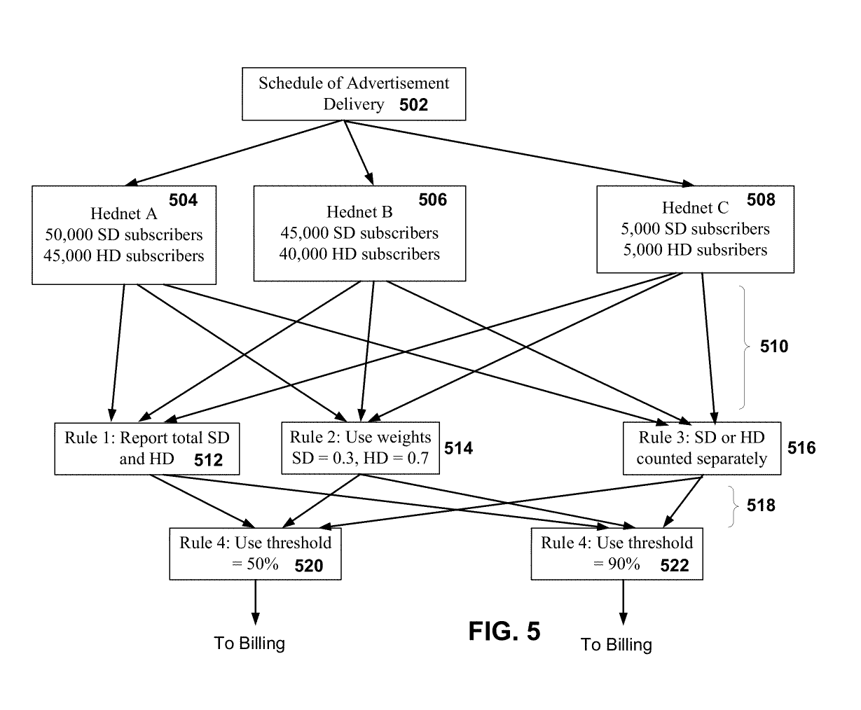

FIG. 5 illustrates the use of different rules, and different tiers of rules, in merging advertisement playback reports. The box 502 represents scheduling of advertisement for delivery into three different networks: headnet A (504) that comprises 50K SD subscribers, of which 45K subscribers receive HD signals also, headnet B (506) that includes 45K subscribers, with 40K subscribers receiving HD delivery format, and headnet C (508) that includes 5K subscribers, all of whom receive both SD and HD format signals.

In some embodiments, the logs 510 include a “yes/no” or a “pass/fail” type binary indication for each advertisement spot whether advertisement was played on the particular headnet or not. For example, a “yes” or “pass” entry for a given advertisement spot may mean that, at the time the advertisement was scheduled to be transmitted over the network, the ad inserter module was indeed able to transmit the corresponding advertisement content to the subscribers of the headnet. In operation, the ad inserter module may either “spool out” a locally stored copy of the advertisement or may retrieve the ad at the given time from an advertisement server reachable over a network connection (e.g., the Internet).

In some embodiments, the logs 510 include a “pass/fail” or “yes/no” binary entry for each delivery format in which content is delivered over the Headnet.

In one example, represented by Rule 1 (512), the above described separate entries for SD and HD versions of an advertisement may be combined so that a total of SD and HD subscribers reached by the advertisement are reported.

In another example, represented by Rule 2 (514), SD content might be given one weight (e.g., 0.3) and the corresponding HD content might be given another weight (0.7) and the number of subscribers reported may be obtained by a weighted combination of the SD and HD subscribers.

In another example, represented by Rule 3 (516), the numbers of subscribers reported to have received the advertisement may be based on counting SD and HD subscribers separately (e.g., a subscriber premise is includes in the final count if it receives SD or HD content).

Other rules may additionally or alternatively used in the above-described rule rubric. Rules may also be organized as tiers or cascades, such that a first tier of rules is applied first and a second tier of rules is applied thereafter on the results of the outputs of applying the first tier of rules.

For example, one tiered rule may be Rule 4 (520) in which a 50% threshold may be used for reporting. Under this rule, an advertisement will be considered to have reached all customers in a network (for billing purpose) if the ad has reached at least 50% of the total subscriber base served (e.g., 100K subscriber premises in the example illustrated in FIG. 5).

Another threshold may be used in Rule 4 (e.g., 90%, as depicted in box 522), and may results in a different billing report, as illustrated further below.

Examples of Merged Reports

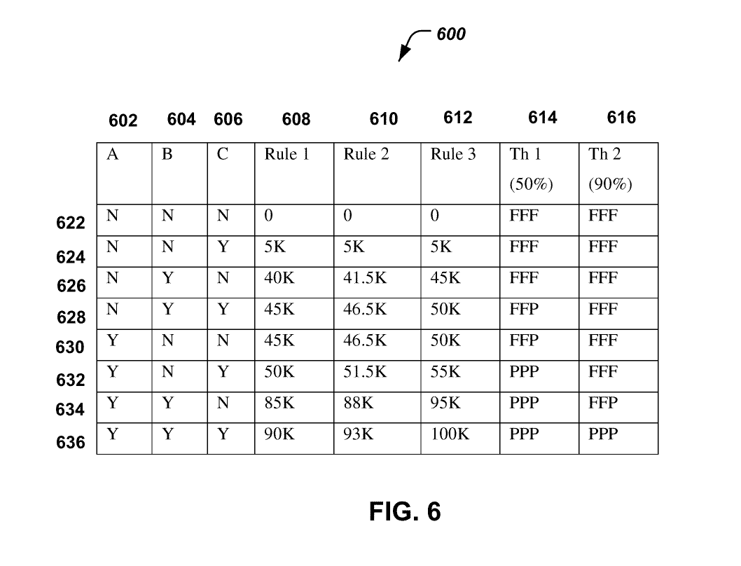

FIG. 6 depicts a table 600 listing different results produced using different rules, e.g., as described with respect to FIG. 5. These results may be included in merged log files that are provided to the billing system. The entries in columns 602, 604 and 606 represent a single entry in the logs 510 for headnets A, B and C 504, 506, 508 respectively. “Y” entries represent that an ad was played out successfully in the corresponding headnet. “N” entries indicate that the ad was not played out in the headnet. The rows 622, 624, 626, 628, 630, 632, 634 and 636 list various possible combinations of advertisement playback entries for the headnets A, B and C.

Column 608 lists results obtained using Rule 1. For example, row 628, column 608 entry “45K” represents the sum of 40K subscribers reached in headnet B (subscribers that were reached by SD and HD delivery formats) plus 5K subscribers reached in headnet C. Similarly, row 636, column 608 entry indicates that 90K subscribers were reached using the “SD and HD” rule 512.

Column 610 lists the corresponding results obtained if Rule 2 (514) were to be used. For example, row 626 corresponds to the scenario in which the advertisement was successfully delivered to headnet B, but failed in headnets A and C. In this case, because headnet B includes 45K SD subscribers, of whom 40K receive HD also, the viewer count for billing is 0.3*45 k+0.7*40K=41.5K.

Column 612 lists the results calculated by applying “SD or HD” rule 516. For example, in row 632, headnets A and C received the ad, but the ad failed to be delivered in headnet B. Therefore, the total number of subscribers to which the ad was delivered either in SD or in HD format includes 50K subscribers in headnet A plus 5K subscribers in headnet C (total 55K).

Column 614 illustrates the use of threshold, e.g., box 520 in FIG. 5, in which a 50% thresholding is applied. Because the total number of subscribers reached by headnets A, B and C combined is 100K, according to this rule, an advertisement is considered to have been delivered to ALL 100K subscribers if the delivery calculations as illustrated in columns 608, 610 or 612 is equal to or greater than 50K, otherwise the ad delivery to ALL subscribers is considered to have failed (for billing purpose). The three alphabets listed in columns 614 and 616 indicate results of thresholding for each column 608, 610 and 612, with “F” indicating failure and “P” indicating success, after the results are thresholded with 50% (or 50K subscribers) for column 614 and 90% (or 90K subscribers) for column 616.

In some implementations, the LogMerge module 414 may verify delivery of spots on all channels (SD, HD, 3D, etc. channels). The LogMerge module 414 may also process multiple Cable Computerized Management System (CCMS) standard verification log files 410 from the inserter 116 and create one master log file 422 based on verification algorithm. In addition, the LogMerge module 414 may provide a user interface to configure the LogMerge utility options and monitor performance of the operation.

The customer would be operating single or multiple traffic systems to generate a CCMS file to schedule airing of ads. Once the Ads are aired, the inserter would return a verification log file for each channel that shows the result of the ads aired (success or fail). If the channel/zone is configured to be merged, the LogMerge utility merges the verification log files for the channels and generates a single verification log file. The Traffic and Billing system 402 would pull (upload) the master merged log files for verification and billing.

Examples of Operational Features

In some implementations, the system 400 further includes a module that processes the CCMS file data and airs/delivers ads as per schedule (e.g., the inserter 116).

In some implementations, the system 400 further includes a module that creates and sends verification log file (CCMS format) for each channel to the Traffic and Billing Systems.

In some implementations, the LogMerge function 414 receives verification log files from the inserter 116.

In some implementations, the LogMerge function 414 does a channels/Zone map lookup to determine if the channel needs to be merged.

If the channel needs to be merged, the LogMerge module 414 merges multiple log files and generates a single master verification log file that contains result status of the ads aired on the channels. Result status is based on verification algorithm. If the channel is not configured to be merged, the LogMerge module 414 does not alter the content of the log file received from the inserter.

As described in this document, in some implementations, the binary “AND” rule is used in merging the various log files. As described in this document, in some implementations, if the spot is delivered on multiple channels (SD/HD), the result will be a success if all channels aired the spot. If either or both channel did not air the spot, the result in the master log file would be a “fail”.

In some implementations, the master verification log file (in CCMS format) is sent to the Traffic and Billing system for verification and Billing.

In some implementations, multiple Traffic and Billing Systems may be supported by a given LogMerge module 414.

In some implementations, merging of files from multiple headends may be performed in a single hardware platform.

In one example, the User Interface used to control the operation of the LogMerge module 414 includes the ability to configure Channel/Zone maps, manually trigger the merge process, enable/disable LogMerge Utility, set up rules and tiers of rules.

In some implementations, a Log Leeway Match Timer may be specified and used to overcome the difference in timing for spots actually delivered and spots scheduled to be delivered.

In some implementations, a Log Leeway Wait Timer may be used to determine the maximum time lapse for receiving multiple log files.

In some implementations, the user may be provided with a Dashboard graphical user interface (GUI) to monitor utility performance.

In some implementations, because a user can specify rule(s) used for merging log files, the system is able to process multiple log files and create one master verification log file based on merge criteria and verification algorithms.

In some implementations, the LogMerge module 414 may include the ability to identify log files that should be merged based on the merge rules specified by the user. If the files do not require merging, the log file received from the inserter is unaltered and passed thru to the Traffic and Billing system.

In some implementations, the LogMerge module 414 may trigger a merge operation automatically. In some embodiments the system monitors input folders for newly created or updated log files and attempt to process a merge any time both input files are present and one of the files have not been previously merged.

In some implementations, the LogMerge module 414 may trigger a merge on schedule. For example, merging may be performed based on the time of day (e.g., performing merge of the previous day's log files at 2 AM the next day).

In some implementations, the LogMerge module 414 may trigger a merge on manual control by a user command. Without the user having to identify which day, time, headend or network, the LogMerge module 414 may automatically process all available log files.

In some implementations, the LogMerge module 414 may process a standard CCMS verification log files from the inserter 116. The Master verification file sent to the Traffic and Billing system may also comply with CCMS format.

In some implementations, the merging multiple log files, the LogMerge module 414 is able to verify the delivery of spots on SD/HD/3D as a single spot based on configured verification algorithm option such as the “AND Verification” rule 512.

As an example, consider two channels that have been schedule to air the spot and merged to create a single spot (master verification log file), then the result status in the master verification log file can be “Success” if both channel log file had success status and “Fail” —if either or both of the channels had a fail status. The master file may copy the fail reason code of the channel and pass it to the Traffic and billing system.

In various embodiments, the run time behavior of the merge operations must is based on user's configured options. A GUI may be provided for an operator to specify rules used for merging log files in different formats. The GUI may use suitable interface widgets such as drop down menus, script editors, file upload tools, etc. to provide a flexible and versatile interface.

In some implementations, the merge process is started when expected log files for the channels to be merged have been received.

In case there are missing log file for the channels to be merged, then in some implementations, merging is based on priority level of the channel to be merged. For example, channels could be “labeled” as primary and secondary. If log file of the primary channel is received but secondary channel log file is missing, then LogMerge utility may send the log file of the primary channel to the T&B system.

In some implementations, the merge operation is based on specific number of channels (user can select which are the minimum channels that could start the merge process).

In some implementations, the system may support multiple Traffic and Billing Systems (T & B) 402 per instance—Single instance of the utility may be configurable to process log files from multiple T&B systems. Utility may have the ability to add/delete/update folders to manage merged files for different T&B systems.

During operations, several merge processing error conditions may occur. The system may raise alert or list error conditions such as follows
Expected file to merge is not received within Log Leeway Wait timer
Missing fields in the received log file
Merge not successful
Database lookup timeout
Log Leeway Wait timer expires
Log Leeway Match-Mismatch condition, etc.

In some implementations, the system generates a point-in-time list of utility activity log: time stamp on received log files, successful merge, merge not successful, # of times expected to log files not received, reason for merge failure, Log Leeway wait and match timer expiration, name of missed log files, average time to handle the merge process, timestamp when merged verification file is sent to T&B system, utility down time, timestamp when log utility is activated/disabled, and so on.

Examples of User Interface

In some implementations, a user interface may be provided for the user to be able to control and monitor the merge operation. User inputs from this interface may be captured by a user input module and the operation of the advertisement verification system may be controlled accordingly. The user interface may include the following features and functions:

Configure options to package the LogMerge utility (License)

Configure options to trigger Merge process Automatic/Manual—(default must be set to Automatic)
Log Leeway Match Timer Mins/Sec. If there is a difference in the timing of spots aired, then consider the spot as aired if it is within Log Leeway Match timer value.
Log Leeway Wait Timer in Hr/Mins. If expected log file is not received within the log leeway timer, then trigger an error.
Configure Channel/Zone Map—Provide user interface to create/update/delete fields in the Channel/Zone maps—manually or automatically.
Configure priority levels for each channel in the channel map—This field is used for determining which channels to merge in case an expected log file for a channel is not received.

For example, if there are 3 channels to be merged and only log files from 1 channels is received then the merge utility will process the merging based on priority levels of the channels of the received log files.
Import Channel/Zone List—Provide user interface to import Channel/Zone list in XML/CSV format and automatically populate the LogMerge utility channel/Zone fields.
Export Channel/Zone List—Ability to export Channel/Zone list from the LogMerge utility in CSV, XML formats.
Import Channel/Zone Map—Ability to import Channel/Zone map. When importing the Channel/Zone maps, the Utility Channel map fields must not overwrite the Channel/Zone list values but can overwrite mapping values.
Export Channel/Zone Map—Ability to export the configured Channel/Zone mapping fields in XML/CSV files
Export Merged Verification log files—Ability to export Merged Verification file in CCMS format to multiple T&B systems.
Set up Email Notification Alerts and users. Provide the administrator the ability to set up email alerts and email addresses/groups for recipients of the alert based on channel maps and error conditions.
Dashboard—The system may provide dashboard that displays “health” of the utility's functionality, e.g., a number of channels processed, average processing time per channel, Number of Master Log files created, error conditions, number of log files not received, system disk space usage, Timestamp of Master file upload by T&B system

In some implementations, the dashboard is be color coded to allow users to quickly detect problems in the merge process

In some implementations, the dashboard includes Headend/channel, timestamp, and enable a user to drill down into specific dates, channels, and zones for problem resolution.

In some implementation, a system operator is able to view the utility log for files that had error status.

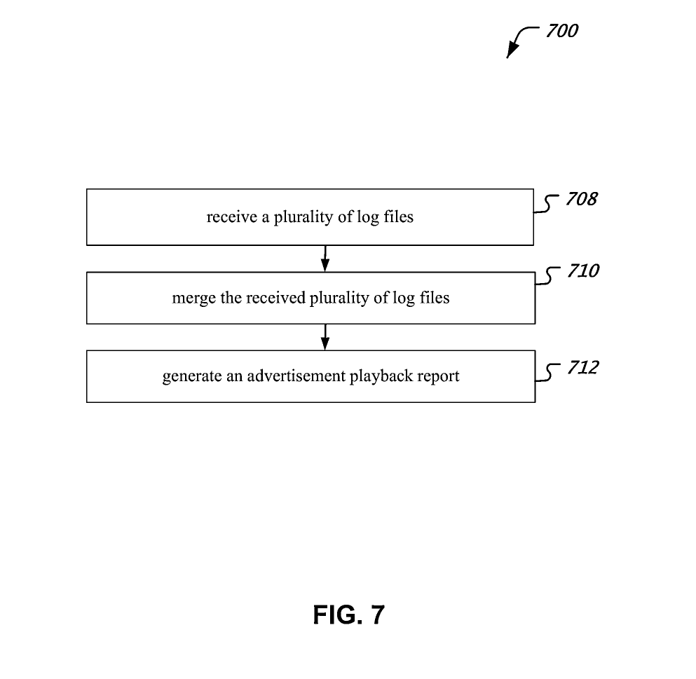

FIG. 7 is a flowchart depiction of a process 700 for generating advertisement playback verification reports.

At 708, at a computer in the content distribution system, a plurality of log files is received from the content distribution system. Each log file (e.g., previously described log files 410, 411, 413) includes information about channels listed an advertisement order (e.g., 404) and playback status for advertisement spots listed in the advertisement order for each channel. The plurality of log files includes, for at least one channel, a first log file (e.g., 411) for delivering a program in a first delivery format and a second log file (e.g., 413) for delivering the program in a second delivery format.

At 710, the received plurality of log files is merged using a merge rule to produce merged log files. As previously described, the merge operation may be based on a rule, or tiers of rules, used to combined, e.g., subscribers reached using SD format and using HD format.

In some implementations, the merge rule specifies a first threshold for the first delivery format and wherein the merging comprises indicating successful delivery of a given advertisement only when a number of subscribers reached by the advertisement, as indicated in the first log file, exceeds the first threshold.

In some implementations, the merge rule specifies a first threshold for the first delivery format and a second threshold for the second delivery format and wherein the merging comprises indicating successful delivery of a given advertisement only when a first number of subscribers reached by the advertisement, as indicated in the first log file, exceeds the first threshold and a second number of subscribers reached by the advertisement, as indicated in the second log file, exceeds the second threshold.

In some implementations, wherein the merge rule specifies a first threshold for the first delivery format and a second threshold for the second delivery format and wherein the merging comprises indicating successful delivery of a given advertisement only when a first number of subscribers reached by the advertisement, as indicated in the first log file, exceeds the first threshold or a second number of subscribers reached by the advertisement, as indicated in the second log file, exceeds the second threshold.

In some implementations, a weighted sum of the reported playback success for the different delivery formats is used, as previously described.

In some implementations, the advertisement report generation may be controlled by a user input so that log merge and generation is performed after a user initiates the operation from a control GUI. In some implementations, the user may have configured to system to perform the merging operation and generate billing data at a particular time of day (e.g., 2 AM) or after elapsing of an amount of time (e.g., 24 hours) since the previous report generation.

At 712, an advertisement playback report is generated based on the merging. The playback report may then be sent to a billing system for billing purpose. As previously discussed, in some implementations, the advertisement playback report comprises merged log files that are merged according to the set of rules applied to the merging operation.

In some implementations, the merge rules may be pre-specified by a user. In some implementations, the merge rule may be changed over a period of time (e.g., every quarter) or may be different for different channels.

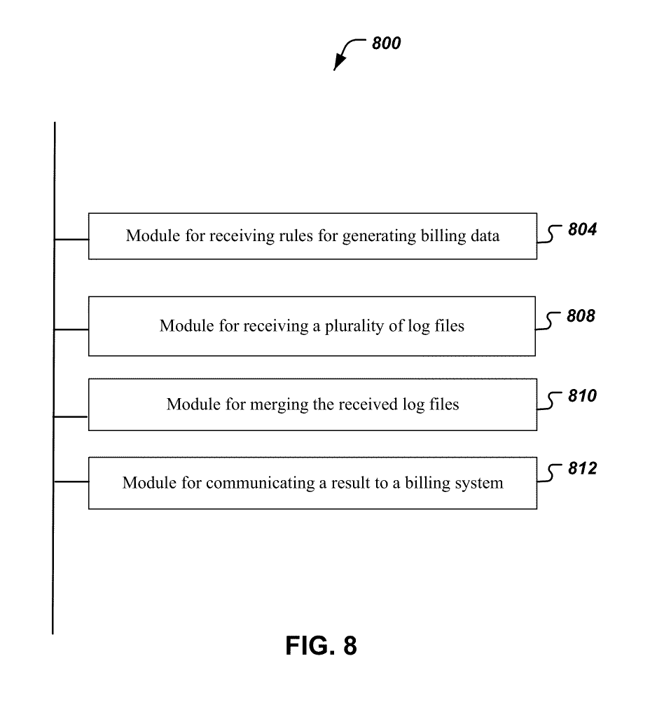

FIG. 8 is a block diagram depicting an apparatus 800 for generating an advertisement playback verification report, the apparatus being operable in a digital cable network comprising one or more cable headends.

The module 804 is for receiving rules for generating billing data for a plurality of channels includes a standard definition (SD) channel and a corresponding high definition (HD) channel.

The module 808 is for receiving a plurality log files from the one or more headends, each log file comprising a list of channels distributed by a corresponding headend and a success status for each advertisement in the advertisement delivery schedule for channels in the list of channels.

The module 810 is for merging the received log files using the rules for generating billing data.

The module 812 is for communicating a result of a report from the log merge module to a billing system.

Some implementations include a billing system, an ad inserter and a merge module. The billing system (e.g., module 402) provides a plurality of schedule files providing time and zone information for inserting advertisement in a first delivery format and in a second delivery format to subscribers of a cable television network. The ad inserter (e.g., module 116) inserts advertisements according to the plurality of schedule files. The merge module (e.g., module 414 or 226) receives a first plurality of log files that provide information about advertisement playback status for the first delivery format and a second plurality of log files that provide information about advertisement playback status for the second delivery format and merges the first plurality of log files and the second plurality of log files according to a set of rules to produce a plurality of merged log files, and delivers the plurality of merged log files to the billing system.

It will be appreciated that techniques are provided to allow flexible reporting back of advertisement playback in multiple delivery formats over a content delivery network such as a digital cable network.

It will further be appreciated that the disclosed mechanism enables a content provider, and advertiser and a network operator to specify various billing options such as counting deliveries of advertisements in a first format (e.g., standard definition television) and a second format (e.g., high definition) either separately, or combined, or a weighted average or be compared to a threshold for billing purpose, and so on.

One of skill in the art will further appreciated that the various techniques described in this document enable the operation and monitoring of advertisement insertion in real life cable networks that often include dozens of headnets, each having hundreds of channels and thousands of advertisement spots possible for each channel every day. It will therefore be appreciated that the operations of receiving a log file and merging log file may require performing millions of calculations in a relatively small time window (e.g., few minutes). Furthermore, for efficiency of communications, the log files may be compressed (zipped) using a computer-implemented method and may require the use of a decompression step after receiving the log files. To meet the fast computational requirements, the reception and decompression steps may be performed by a processor or using a special purpose circuitry.

The disclosed and other embodiments, modules and the functional operations described in this document (e.g., a schedule receiver, a rule receiver, an inserter control module, a log file receiver, a log merge module, a billing data creation module, a user input module, a billing time generator module, etc.) can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is what is disclosed and illustrated, including:

1. A computer implemented method for reporting advertisement playback in a content distribution system to a billing server, the method comprising:
receiving, at a computer in the content distribution system, a plurality of log files from the content distribution system, each log file comprising information about channels listed an advertisement order and playback status for advertisement spots listed in the advertisement order for each channel, wherein, the plurality of log files includes, for at least one channel, a first log file for delivering a program in a first delivery format and a second log file for delivering the program in a second delivery format;
merging the received plurality of log files based on a merge rule to produce merged log files; and
generating an advertisement playback report based on the merged log files.

2. The method of claim 1, wherein
the first delivery format comprises one of a high definition delivery format, a standard definition delivery format or a 3-dimensional delivery format; and
the second delivery format comprises another one of a high definition delivery format, a standard definition delivery format or a 3-dimensional delivery format.

3. The method of claim 2, wherein the merge rule specifies a first threshold for the first delivery format and wherein the merging comprises indicating successful delivery of a given advertisement only when a number of subscribers reached by the advertisement, as indicated in the first log file, exceeds the first threshold.

4. The method of claim 2, wherein the merge rule specifies a first threshold for the first delivery format and a second threshold for the second delivery format and wherein the merging comprises indicating successful delivery of a given advertisement only when a first number of subscribers reached by the advertisement, as indicated in the first log file, exceeds the first threshold and a second number of subscribers reached by the advertisement, as indicated in the second log file, exceeds the second threshold.

4. The method of claim 2, wherein the merge rule specifies a first threshold for the first delivery format and a second threshold for the second delivery format and wherein the merging comprises indicating successful delivery of a given advertisement only when a first number of subscribers reached by the advertisement, as indicated in the first log file, exceeds the first threshold or a second number of subscribers reached by the advertisement, as indicated in the second log file, exceeds the second threshold.

5. The method of claim 1, wherein the merge rule comprises a first weight for the first delivery format and a second weight for the second delivery format, and wherein the merging comprises calculating a weighted sum of results from the first log file and results from the second log file.

6. The method of claim 1, wherein the generating the advertisement playback report comprises at least one of generating the advertisement report in response to the user input and generating the advertisement report in response to a pre-specified time.

7. The method of claim 1, wherein the merge rule comprises a first tier rule and a second tier rule and wherein the log files are first merged by applying the first tier rule and the second tier rule is applied to results of the first merging.

8. The method of claim 1, wherein the merge rule is a pre-specified rule received from a user.

9. An apparatus for generating an advertisement playback verification report, the apparatus being operable in a digital cable network comprising one or more cable headends, the apparatus comprising:
a rule receiver that receives rules for generating billing data for a plurality of channels comprising a standard definition (SD) channel and a corresponding high definition (HD) channel;
a log file receiver that receives a plurality log files from the one or more headends, each log file comprising a list of channels distributed by a corresponding headend and a success status for each advertisement in the advertisement delivery schedule for channels in the list of channels;
a log merge module that merges the received log files using the rules for generating billing data; and
a billing data creation module that communicates a result of a report from the log merge module to a billing system.

10. The apparatus of claim 9, wherein the rules for generating billing data include an and rule and wherein the log merge module indicates in the billing data that an advertisement corresponding to an entry in the received advertisement delivery schedule was successfully delivered to a particular headend, when received log files from the particular headed indicate that the advertisement was successfully delivered for both the standard definition channel and the high definition channel.

11. The apparatus of claim 9, wherein the rules for generating billing data include an and rule and wherein the log merge module indicates in the billing data that an advertisement corresponding to an entry in the received advertisement delivery schedule was successfully delivered to a particular headend, when received log files from the particular headed indicate that the advertisement was successfully delivered for either the standard definition channel or the high definition channel.

12. The apparatus of claim 9, wherein the rules for generating billing data include a rule specifying a first weight and a second weight and wherein the log merge module indicates in the billing data that an advertisement corresponding to an entry in the received advertisement delivery schedule was successfully delivered to a number of subscribers served by a particular headend, wherein the number of subscribers is calculated using a weighted sum of a first number of subscribers served the standard definition channel and a second number of subscriber served the high definition channel, using the first weight and the second weight.

13. The apparatus of claim 1, further comprising:
a user input module to receive a user instruction to generate a billing report and wherein the billing data creation module is responsive to the user instruction.

14. The apparatus of claim 9, wherein the rules for generating billing data include at least two tiers of rules and wherein:
the log merge module merges the received log files using a first rule from a first tier of rules and the billing data creation module generates the result of the report from the log merge module using a second rule from a second tier of rules.

15. The apparatus of claim 1, further comprising:
a billing time generator module that instructs the billing data creation module to communication the result to the billing system based on a time elapsed since a last result was communicated to the billing system.

16. A computer program product comprising a computer-readable storage medium having code stored thereupon, the code, when executed by a processor, causing the processor to implement a method of reporting advertisement playback in a content distribution system, the method comprising:
receiving, at a computer in the content distribution system, a plurality of log files from the content distribution system, each log file comprising information about channels listed an advertisement order and playback status for advertisement spots listed in the advertisement order for each channel, wherein, the plurality of log files includes, for at least one channel, a first log file for delivering a program in a first delivery format and a second log file for delivering the program in a second delivery format;
merging the received plurality of log files using a merge rule to produce merged log files; and
generating an advertisement playback report based on the merged log files.

17. The computer program product of claim 16, wherein:
the first delivery format comprises one of a high definition delivery format, a standard definition delivery format or a 3-dimensional delivery format; and
the second delivery format comprises another one of a high definition delivery format, a standard definition delivery format or a 3-dimensional delivery format.

18. The computer program product of claim 16, wherein the merge rule specifies a first threshold for the first delivery format and wherein the merging comprises indicating successful delivery of a given advertisement only when a number of subscribers reached by the advertisement, as indicated in the first log file, exceeds the first threshold.

19. The computer program product of claim 16, wherein the merge rule specifies a first threshold for the first delivery format and a second threshold for the second delivery format and wherein the merging comprises indicating successful delivery of a given advertisement only when a first number of subscribers reached by the advertisement, as indicated in the first log file, exceeds the first threshold and a second number of subscribers reached by the advertisement, as indicated in the second log file, exceeds the second threshold.

20. An advertisement delivery system, comprising:
a billing system that provides a plurality of schedule files providing time and zone information for inserting advertisement in a first delivery format and in a second delivery format to subscribers of a cable television network;
an ad inserter that inserts advertisements according to the plurality of schedule files; and
a merge module that receives a first plurality of log files that provide information about advertisement playback status for the first delivery format and a second plurality of log files that provide information about advertisement playback status for the second delivery format and merges the first plurality of log files and the second plurality of log files according to a set of rules to produce a plurality of merged log files, and delivers the plurality of merged log files to the billing system.
